(19) United States
(12) Patent Application Publication
(10) Pub. No.: US 2025/0289949 A1
(43) Pub. Date: Sep. 18, 2025

(54) RUBBER COMPOSITIONS AND ARTICLES THEREOF

(71) Applicant: The Goodyear Tire & Rubber Company, Akron, OH (US)

(72) Inventors: Andreas Frantzen, Trier (DE); Lothar Braun, Bollendorf (DE); Clemens Sill, Trier (DE); Serge Marnach, Weiswampach (LU); Francois Kayser, Luxembourg (LU); Anne-Catherine Fischer, Beyren-lès-Sierck (FR)

(21) Appl. No.: 18/606,969

(22) Filed: Mar. 15, 2024

(51) Int. Cl. C08L 23/20; B60C 1/00; C08K 5/00; C08K 5/14; C08K 5/33

(52) U.S. Cl. CPC C08L 23/20; B60C 1/00; C08K 5/0025; C08K 5/14; C08K 5/33

(57) ABSTRACT

In accordance with the purpose(s) of the present disclosure, as embodied and broadly described herein, the disclosure, in one aspect, relates to uncured compositions that include an elastomer, a curing agent, a co-curative, and a diluent, where the diluent comprises a highly reactive polyisobutene with at least about 60 mol % of terminal vinylidene groups. In certain aspect, the diluent can include a second diluent comprising a second polyisobutene comprising at most about 20 mol % terminal vinylidene groups, a hydrocarbon oil, or a combination thereof. Also disclosed are vulcanized rubber compositions including the uncured compositions that have been vulcanized and articles, including tires and/or components of tires, comprising the vulcanized rubber compositions.

### BACKGROUND

The demand for improved tire performance has resulted in the development and evaluation of new materials that, when incorporated into rubber compositions, demonstrate desired properties such as good stiffness and elasticity. For elastomer compositions used in the construction of tires, such as sealants, developing compositions with improved and tunable viscoelastic properties without compromising processability can be challenging. Sealant layers applied directly to a tire after the cure process are referred to as post-cure sealants. Such sealants are in some cases adhesively secured to the exposed surface of the tire, such as the innermost inner liner. These post-cure sealants may not provide adequate long-term seal against puncturing objects. Therefore, there is a need for improved post-cure sealants for tires, in addition to a general need for improved elastomer compositions used in the construction of tires.

### SUMMARY

In accordance with the purpose(s) of the present disclosure, as embodied and broadly described herein, the disclosure, in one aspect, relates to uncured compositions that include an elastomer, a curing agent, a co-curative, and a diluent, where the diluent comprises a highly reactive polyisobutene with at least about 60 mol % of terminal vinylidene groups. In certain aspect, the diluent can include a second diluent comprising a second polyisobutene comprising at most about 20 mol % terminal vinylidene groups, a hydrocarbon oil, or a combination thereof. Also disclosed are vulcanized rubber compositions including the uncured compositions that have been vulcanized and articles, including tires and/or components of tires, comprising the vulcanized rubber compositions.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a cured composition prepared from a diluent mixture of 30% highly reactive polyisobutene (HR-PIB) and 70% conventional polyisobutene (C-PIB) results in 26% increase or 1.25 times higher elastic modulus G′ based on ASTM D5289 when compared to a cured composition that does not include HR-PIB.

FIG. 2 shows a cured composition prepared from a diluent composed of 100% highly reactive polyisobutene (HR-PIB) results in 140% increase or 2.4 times higher elastic modulus G′ based on ASTM D5289 when compared to a cured composition that does not include HR-PIB.

FIG. 3 shows a cured composition prepared from a diluent mixture of 30% highly reactive polyisobutene (HR-PIB) and 70% conventional polyisobutene (C-PIB) results in 33% increase or 1.55 times higher elastic modulus G′ based on ASTM D4440 when compared to a cured composition that does not include HR-PIB.

FIG. 4 shows a cured composition prepared from a diluent composed of 100% highly reactive polyisobutene (HR-PIB) results in 350% increase or 4.5 times higher elastic modulus G′ based on ASTM D5289 when compared to a cured composition that does not include HR-PIB.

FIG. 5 shows a cured composition prepared from a diluent mixture of 30% highly reactive polyisobutene (HR-PIB) and 70% conventional polyisobutene (C-PIB) results in 30% reduction of loss factor tan delta based on ASTM D4440 when compared to a cured composition that does not include HR-PIB.

FIG. 6 shows a cured composition prepared from a diluent composed of 100% highly reactive polyisobutene (HR-PIB) results in 97.5% reduction of loss factor tan delta based on ASTM D4440 when compared to a cured composition that does not include HR-PIB.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an,” and “the” include plural referents unless the context clearly dictates otherwise. Thus, for example, reference to “an elastomer,” “a pre-silanized silica,” or “a vulcanizing agent,” include, but are not limited to, mixtures or combinations of two or more such elastomers, pre-silanized silicas, or vulcanizing agents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers elastomers is in accordance with claimed phr ranges and the amount of all rubbers/elastomers in the composition results in total in 100 parts of rubber.

The terms “rubber” and “elastomer” may be used herein interchangeably, unless indicated otherwise.

As used herein, the term “uncured composition” refers to a composition including at least one natural or synthetic rubber component and, optionally, one or more fillers, processing aids, or additional compounds, that has not been vulcanized. Uncured rubber is sensitive to changes in temperature and has a tendency to undergo “cold flow” (slow movement or deformation under stress) over time. In one aspect, the uncured rubber composition is a masterbatch.

As used herein, the term “vulcanized rubber composition” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In another aspect, rubber compositions can be cured in molds in order to form finished articles including, but not limited to, tires.

As used herein, the term “repeat unit” as referenced in the partially saturated elastomers described herein are derived from monomers used to produce the partially saturated elastomers. For example, polybutadiene has the repeat unit as provided below.

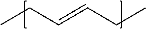

In certain aspects, when the partially saturated elastomer is the polymerization product of two different monomers (e.g., A and B), the repeat unit can be represented by -A-B-.

Unless otherwise specified, pressures referred to herein are based on atmospheric pressure (i.e. one atmosphere).

### Rubber Compositions

Disclosed herein are uncured sealant compositions, including post-cure sealant compositions, comprising an elastomer, a curing agent, a co-curative, and a diluent, where the diluent includes a highly reactive polyisobutene (HR-PIB). In sealant compositions, HR-PIB has been found, unexpectedly, to interact with the curing agent and actively contribute to crosslink formation, increasing stiffness and elasticity in the cured composition with increasing HR-PIB content. This allows for the resulting composition's crosslink density and other properties to be tuned by varying the relative amount of HR-PIB. In certain aspects, blending other materials with HR-PIB to form the diluent, such as oils or conventional PIB (C-PIB), can allow for improvement and cost-effective tuning of the resulting composition's properties.

The diluent in the sealant composition includes a highly reactive polyisobutene (HR-PIB), which is characterized by including at least about 60 mol % of terminal vinylidene groups. Terminal functional groups, such as terminal vinylidene groups, are functional groups located at the end of a carbon chain (i.e., the terminal position). In further aspects, the HR-PIB can include at least 75 mol % of terminal vinylidene groups. In another aspect, the HR-PIB can include at least about 60 mol %, 65 mol %, 70 mol %, 75 mol %, 80 mol %, 85 mol %, 90 mol %, or 95 mol % of terminal vinylidene groups, where any value can be a lower and upper endpoint of a range (e.g., 70 mol % to 85 mol %). In one aspect, the HR-PIB has a number average molecular weight ranging from about 500 Da to about 5,000 Da or about 500 Da, 1,000 Da, 2,000 Da, 3,000 Da, 4,000 Da, or 5,000 Da, where any value can be a lower and upper endpoint of a range (e.g., 500 Da to 1,000 Da).

The diluent can further include a second diluent. In one aspect, the second diluent includes a second polyisobutene, characterized by including at most about 20 mol % terminal vinylidene groups. In further aspects, the second polyisobutene can include at most about 10 mol % of terminal vinylidene groups. In another aspect, the second polyisobutene can include at most about 5 mol %, 10 mol %, 15 mol %, or 20 mol % of terminal vinylidene groups, where any value can be a lower and upper endpoint of a range (e.g., 5 mol % to 20 mol %). In one aspect, the second polyisobutene has a number average molecular weight ranging from about 500 Da to about 5,000 Da or about 500 Da, 1,000 Da, 2,000 Da, 3,000 Da, 4,000 Da, or 5,000 Da, where any value can be a lower and upper endpoint of a range (e.g., 500 Da to 1,000 Da).

In other aspects, the second diluent can include a hydrocarbon oil. Examples of the hydrocarbon oil include, but are not limited to, a mineral oil, a vegetable oil, or a combination thereof. Mineral oils can include, but are not limited to, aromatic oils, naphthenic oils, paraffinic oils, MES oils, TDAE oils, RAE oils, and SRAE oils. Vegetable oils can include, but are not limited to, sunflower oil, soybean oil, corn oil, castor oil, and canola oil. In other aspects, the second diluent can include a combination of the second polyisobutene and a hydrocarbon oil.

In one aspect, the weight ratio of the HR-PIB to the second diluent (HR-PIB: second diluent) can be about 1:20 to about 20:1 or about 1:20, 1:15, 1:10, 1:5, 1:4, 1:2, 1:1, 2:1, 4:0, 5:1, 10:1, 15:1, or 20:1, where any value can be a lower and upper endpoint of a range (e.g., 1:20 to 1:5). In one aspect, the diluent (including HR-PIB and the second diluent) is present in the sealant composition in amounts of about 10 wt % to about 80 wt % or about 10 wt %, 20 wt %, 30 wt %, 40 wt %, 50 wt %, 60 wt %, 70 wt %, or 80 wt %, where any value can be a lower and upper endpoint of a range (e.g., 50 wt % to 80 wt %). In another aspect, the diluent (including HR-PIB and the second diluent) is present in the sealant composition in amounts of about 100 phr to about 600 phr or 100 phr, 150 phr, 200 phr, 250 phr, 300 phr, 350 phr, 400 phr, 450 phr, 500 phr, 550 phr, or 600 phr, where any value can be a lower and upper endpoint of a range (e.g., 200 phr to 500 phr). In other aspect, the diluent consists of HR-PIB (i.e., the diluent is 100% HR-PIB).

In one aspect, the elastomer can be present in the sealant composition in amounts of about 10 wt % to about 50 wt % or 10 wt %, 20 wt %, 30 wt %, 40 wt %, or 50 wt %, where any value can be a lower and upper endpoint of a range (e.g., 20 wt % to 40 wt %). In one aspect, the elastomer comprises repeat units formed by residues of monomers selected from one or more of ethylene, propylene, isobutene, butadiene, isoprene, styrene, acrylonitrile, and any combination thereof.

In other aspects, the elastomer can be selected from isoprene-isobutylene-rubber (Butyl rubber, IIR), halogenated isoprene-isobutylene-rubber (HIIR), ethylene-propylene-diene-terpolymer (EPDM), styrene-butadiene copolymer (SBR), acrylonitrile-butadiene copolymer (AB), acrylonitrile-butadiene-styrene copolymer (ABS), polybutadiene, natural rubber, cis polyisoprene, and any combination thereof. In further aspects, the elastomers generally having a number average molecular weight (Mₙ) between 100,000 Da and 500,000 Da. Molecular weight Mn may be determined by methods known in the art, such as by gel permeation chromatography following ASTM D3536 or equivalent.

In one aspect, the elastomer is a butyl rubber, comprising repeat units of isobutene and a conjugated diene. In one aspect, about 85 wt % to about 99.5 wt % of the butyl rubber is repeat units of isobutene, or about 85 wt %, 90 wt %, 95 wt %, or 99 wt %, where any value can be a lower and upper endpoint of a range (e.g., 90 wt % to 99 wt %). In one aspect, about 0.1 wt % to about 15.0 wt % of the butyl rubber is repeat units of a conjugated diene, or about 0.1 wt %, 3 wt %, 6 wt %, 9 wt %, 12 wt %, or 15 wt %, where any value can be a lower and upper endpoint of a range (e.g., 3 wt % to 6 wt %). In further aspects, the conjugated diene has from 4 to 8 carbon atoms, such as butadiene, isoprene, and hexadiene. In other aspects, the conjugated diene is isoprene.

In one aspect, the curing agent can be present in the sealant composition in amounts of about 0.5 wt % to about 5.0 wt % or 0.5 wt %, 1.0 wt %, 2.0 wt %, 3.0 wt %, 4.0 wt %, or 5.0 wt %, where any value can be a lower and upper endpoint of a range (e.g., 2.0 wt % to 4.0 wt %). In one aspect, the curing agent present in the sealant composition is a quinoid curing agent. In further aspects, the curing agent can be selected from benzoquinone dioxime (BQD), dibenzoyl-p-quinone dioxime, p,p-di-benzoylquinone dioxime, p-dinitrosobenzene, N-methyl-N,4-dinitrosoanilene, or any combination thereof. In other aspects, the curing agent is BQD.

In one aspect, the co-curative can be present in the sealant composition in amounts of about 1 wt % to about 15 wt % or about 1 wt %, 3 wt %, 6 wt %, 9 wt %, 12 wt %, or 15 wt %, where any value can be a lower and upper endpoint of a range (e.g., 9 wt % to 12 wt %). In one aspect, the co-curative is an oxidant. In further aspects, the co-curative is an organic peroxide. In one aspect, the organic peroxide can be selected from diaroyl peroxides, diacyl peroxides, and peroxyesters. In a further aspect, the co-curative is dibenzoyl peroxide. In other aspects, the co-curative is selected from ZnO, MgO, CaO, or any combination thereof. In one aspect, the sealant composition includes a dibenzoyl peroxide co-curative and a BQD curing agent.

In one aspect, resins are also present in the sealant compositions. Suitable resins include, but are not limited to, hydrocarbon resins, phenol/acetylene resins, rosin derived resins, and mixtures thereof. Hydrocarbon resins can include coumarone-indene-resins, petroleum resins, terpene polymers, and mixtures thereof.

### Preparation and Applications of Rubber Compositions

The compositions disclosed herein can be compounded by methods generally known in the rubber compounding art. In one aspect, these methods including mixing the aforementioned components of the sealant composition with other conventional compounding ingredients, including filler, such as carbon black and silica; antidegradants, such as antioxidants and antiozonants; colorants; processing aids; cure accelerators; cure retarders; and the like. In one aspect, cure accelerators can be selected from dithiocarbamate accelerators, thiuram accelerators, diphenylguanidine accelerators, benzothiazole sulfenamide accelerators, or any combination thereof. The cure accelerators can include derivatives: e.g., a benzothiazole sulfenamide accelerator includes benzothiazole sulfenamide and can also include derivatives of benzothiazole sulfenamide. In other aspects, the cure accelerators can include amines, disulfides, guanidines, thioureas, thiazoles, thiurams, sulfenamides, dithiocarbamates, and xanthates. In one aspect, cure retarders can be selected from ethylene glycol, alkyl-substituted ethylene glycols, ethylene diamine, and alkyl-substituted ethylene diamines. In further aspects, cure retarders can be selected from ethylene glycol, propylene glycol (i.e., a-propylene glycol), ethylene diamine, methyl ethylene diamine, N,N-dimethyl ethylene diamine, and 1,2-dimethyl ethylene diamine. In one aspect, antioxidants and antioxidants can each individually be included in amounts of about 1 phr to 5 phr. In one aspect, antioxidants can be selected from diphenyl-p-phenylenediamine and others, such as those disclosed in The Vanderbilt Rubber Handbook (1978), Pages 344 through 346. In other aspects, antiozonants can be selected from N-phenyl-N′-(1,3-dimethylbutyl)-p-phenylenediamine (6PPD) and N,N′-dixylene-p-phenylenediamine (DTPD). In other aspects, basic oxides, such as zinc oxide, magnesium oxide, and calcium oxide, can be included in amounts of about 1 phr to about 5 phr. Mixing of the sealant composition can be accomplished for example by combining the elastomers and other components in a rubber mixer such as a Brabender internal mixer, extruder, conical mixer, or the like. A suitable process for mixing the sealant and applying to a tire innerliner is as disclosed for example in U.S. Pat. No. 8,821,982, which is incorporated herein by reference.

Also disclosed herein are rubber compositions comprising any of the sealant compositions disclosed herein that have been vulcanized and articles that include the vulcanized sealant compositions. In one aspect, the article comprises a tire, such as a pneumatic tire, or a component of a tire. The tire can be a race tire, passenger tire, aircraft tire, agricultural, earthmover, off-the-road, truck tire, or the like. In one embodiment, the tire is a passenger or truck tire. The tire can also be a radial or bias. Such tires can be built, shaped, molded and cured by various methods which are known and will be readily apparent to those having skill in such art. The component of the tire can be a tread, base, sidewall, apex, chafer, sidewall insert, wirecoat, innerliner, or any combination thereof. In further aspects, the sealant composition can be applied to a cured tire. In further aspects, the sealant composition can be applied to the innerliner of a cured tire. Prior to application of the sealant, the tire can be cleaned of surface impurities to improve adhesion of the sealant to the tire surface. In one embodiment, the tire innerliner surface is cleaned using a laser technique as described in US 2017/0151740, and said technique is incorporated herein by reference.

The use of highly reactive polyisobutene (HR-PIB) in the presence or absence of a second diluent can modify the physical properties of the cured rubber compositions described herein. In one aspect, the elastic modulus of the cured rubber composition can be modified. In one aspect, the cured rubber composition has an elastic modulus G′ at a strain of 6.1%, 70° C., and a frequency of 1.672 Hz based on ASTM D5289 that is at least 20% greater, 30% greater, 40% greater, 50% greater, 75% greater, and up to 100% greater than the elastic modulus G′ of a cured composition that does not comprise a highly reactive polyisobutene. In another aspect, the cured rubber composition has an elastic modulus G′ at a strain of 0.5%, 60° C., and a frequency of 0.005 Hz based on ASTM D4440 that is at least 30% lower, 40% lower, 50% lower, 75% lower, and up to 100% lower than the loss factor tan delta of a cured composition that does not comprise a highly reactive polyisobutene.

In another aspect, the cured rubber composition has a loss factor tan delta at a strain of 0.5%, 60° C., and a frequency of 0.005 Hz based on ASTM D4440 that is at least 30% lower, 40% lower, 50% lower, 75% lower, and up to 100% lower than the loss factor tan delta of a cured composition that does not comprise a highly reactive polyisobutene.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered Aspects, which should not be confused with the claims.

Aspect 1. An uncured composition comprising:
an elastomer, a curing agent, a co-curative, and a diluent, wherein the diluent comprises a highly reactive polyisobutene that comprises at least about 60 mol % of terminal vinylidene groups.

Aspect 2. The composition of Aspect 1, wherein the diluent consists of the highly reactive polyisobutene.

Aspect 3. The composition of Aspect 1, wherein the diluent comprises a second diluent comprising a second polyisobutene comprising at most about 20 mol % terminal vinylidene groups, a hydrocarbon oil, or a combination thereof.

Aspect 4. The composition of Aspect 3, wherein the weight ratio of the highly reactive polyisobutene to the second diluent is about 1:20 to about 20:1.

Aspect 5. The composition of Aspect 3, wherein the weight ratio of the highly reactive polyisobutene to the second diluent is about 1:20 to about 1:2.

Aspect 6. The composition of any one of Aspects 3-5, wherein the second diluent comprises a second polyisobutene comprising at most about 10 mol % of terminal vinylidene groups.

Aspect 7. The composition of any one of Aspects 3-5, wherein the second diluent comprises a second polyisobutene comprising from about 5 mol % to at most 20 mol % of terminal vinylidene groups.

Aspect 8. The composition of any one of Aspects 3-7, wherein the second polyisobutene has an average molecular weight of about 500 Dalton to about 5,000 Dalton.

Aspect 9. The composition of any one of Aspects 3-5, wherein the second diluent comprises a hydrocarbon oil.

Aspect 10. The composition of any one of Aspects 3-5, wherein the hydrocarbon oil comprises a mineral oil, a vegetable oil, or a combination thereof.

Aspect 11. The composition of any one of Aspects 1-10, wherein the highly reactive polyisobutene comprises at least 75 mol % of terminal vinylidene groups.

Aspect 12. The composition of any one of Aspects 1-10, wherein the highly reactive polyisobutene comprises from about 60 mol % to less than 95 mol % terminal vinylidene groups.

Aspect 13. The composition of any one of Aspects 1-12, wherein the highly reactive polyisobutene has an average molecular weight of about 500 Dalton to about 5,000 Dalton.

Aspect 14. The composition of any one of Aspects 1-13, wherein the elastomer comprises repeat units formed by residues of monomers selected from one or more of ethylene, propylene, isobutene, butadiene, isoprene, styrene, acrylonitrile, and any combination thereof.

Aspect 15. The composition of any one of Aspects 1-14, wherein the curing agent is a quinoid.

Aspect 16. The composition of any one of Aspects 1-14, wherein the curing agent is selected from the group consisting of benzoquinone dioxime, p,p-dibenzoylquinone dioxime, dibenzoyl-p-quinone dioxime, p-dinitrosobenzene, N-methyl-N, 4-dinitrosoanilene, and any combination thereof.

Aspect 17. The composition of any one of Aspects 1-16, wherein the co-curative is an oxidant.

Aspect 18. The composition of any one of Aspects 1-16, wherein the co-curative is an organic peroxide.

Aspect 19. The composition of any one of Aspects 1-16, wherein the co-curative is a diaroyl peroxide. a diacyl peroxide, or a peroxyester.

Aspect 20. The composition of any one of Aspects 1-16, wherein the curing agent is benzoquinone dioxime and the co-curative is dibenzoyl peroxide.

Aspect 21. The composition of any one of Aspects 1-20, wherein the diluent is from about 50 weight percent to about 80 weight percent of the composition.

Aspect 22. A vulcanized rubber composition comprising the uncured composition of any one of Aspects 1-21 that has been vulcanized.

Aspect 23. The composition in Aspect 22, wherein the composition after cure has an elastic modulus G′ at a strain of 6.1%, 70° C., and a frequency of 1.672 Hz based on ASTM D5289that is at least 20% greater than the elastic modulus G′ of a cured composition that does not comprise a highly reactive polyisobutene.

Aspect 24. The composition in Aspect 22, wherein the composition after cure has an elastic modulus G′ at a strain of 0.5%, 60° C., and a frequency of 0.005 Hz based on ASTM D4440that is at least 30% lower than the loss factor tan delta of a cured composition that does not comprise a highly reactive polyisobutene.

Aspect 25. The composition in Aspect 22, wherein the composition after cure has a loss factor tan delta at a strain of 0.5%, 60° C., and a frequency of 0.005 Hz based on ASTM D4440that is at least 30% lower than the loss factor tan delta of a cured composition that does not comprise a highly reactive polyisobutene.

Aspect 26. An article comprising the vulcanized rubber composition of any one of Aspects 22-25.

Aspect 27. The article of Aspect 26, wherein the article comprises a tire or a component of a tire.

Aspect 28. The article of Aspect 27, wherein the component of the tire comprises a tread, sidewall, apex, chafer, sidewall insert, wirecoat, innerliner, or any combination thereof.

### EXAMPLES

The following examples are put forth so as to provide those of ordinary skill in the art with a complete disclosure and description of how the compounds, compositions, articles, devices and/or methods claimed herein are made and evaluated. These examples are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in° C. or is at ambient temperature, and pressure is at or near atmospheric.

### Example 1: Evaluation of Rubber Compositions

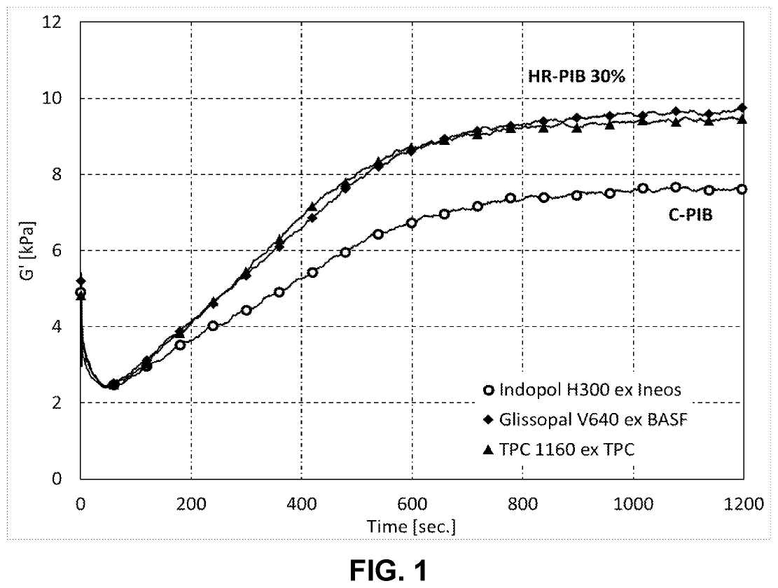

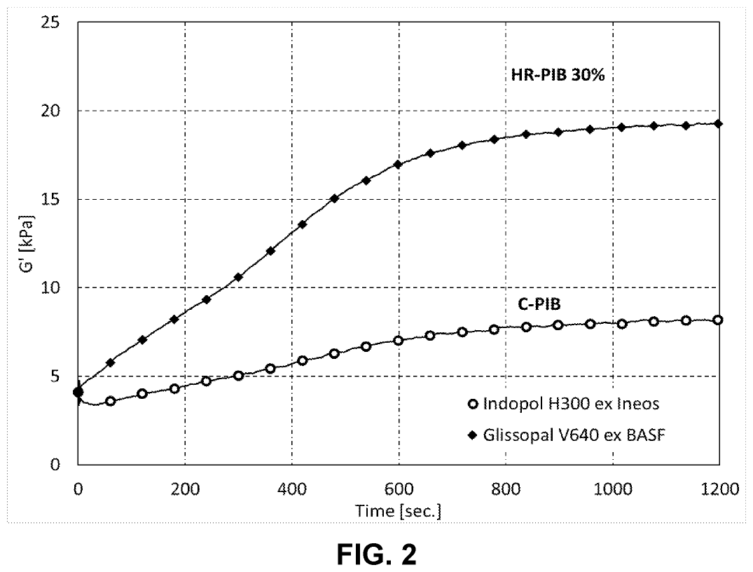

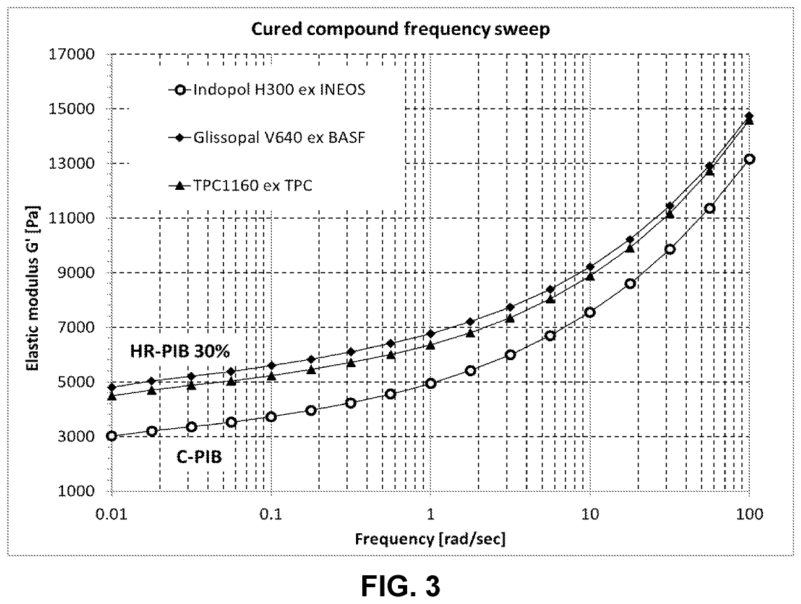

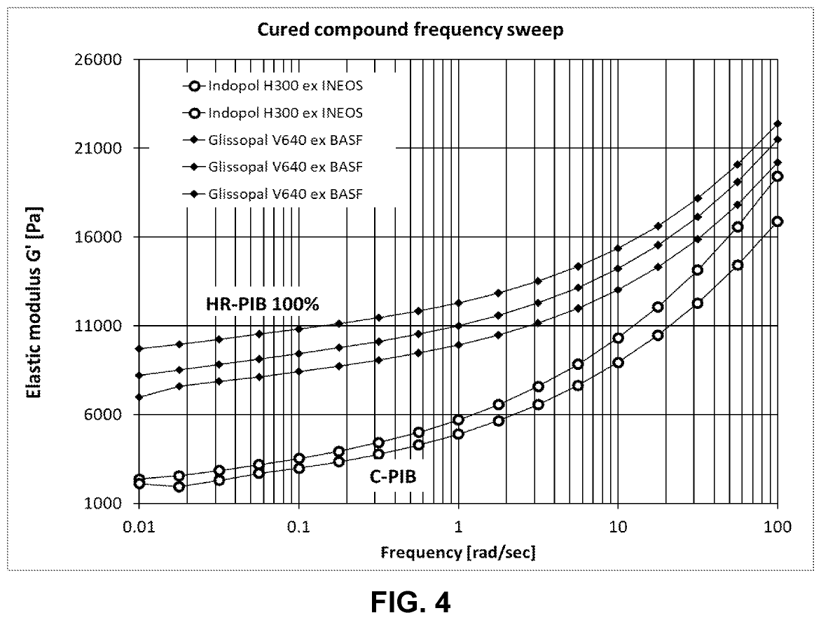

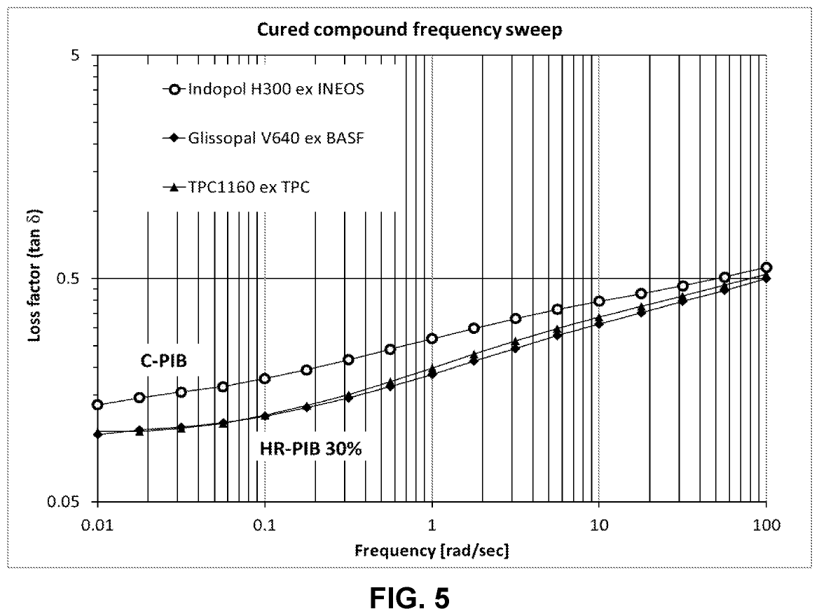

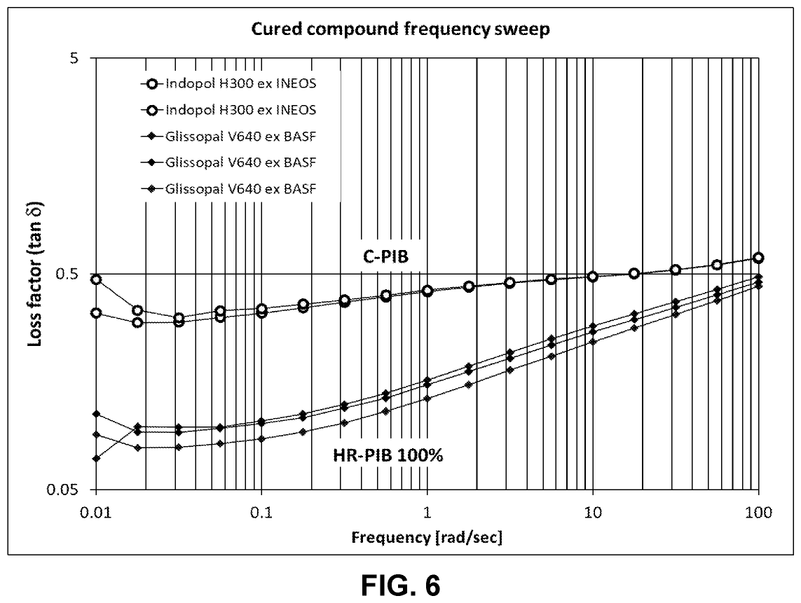

The rheological properties of cured rubber compositions described herein were evaluated. The test methods for evaluating the cured compositions is provided in Table 1. The test results are provided in Table 2 and FIGS. 1-6.

TABLE 1

| ASTM | | D 5289 (RPA) | | D 4440 (Rheology) |
|---|---|---|---|---|
| Equipment | | D-RPA 3000 | | MCR 102 |
| | | Company | | Company Anton |
| | | Montec | | Paar |
| Sample | | Uncured sealant | | Cured sealant |
| Geometry | | Biconical die | | Plate-plate |
| Amount | | 5 | g | 1 mm gauge |
| Protocol | | Isotherm, at | | Isothermal, |
| | | constant | | frequency |
| | | strain and | | sweep at constant |
| | | frequency | | strain |
| Set parameter | strain | 6.1% | | 0.5% |
| | frequency | 1.672 | Hz | 0.001 Hz to 10 Hz |
| | temperature | 70° | C. | 60° C. |
| | time | 20 | min | |

TABLE 2

| | | | 30% HR-PIB | 30% HR-PIB | |
|---|---|---|---|---|---|
| | | Reference | (TPC 1160) | (TPC 1160) | 100% HR-PIB |
| | | 100% C-PIB | 70% C-PIB | 70% C-PIB | (Glissopal |
| | | (Indopol H300) | (Indopol H300) | (Indopol H300) | V640) |
| RPA | G′ [kPa] after | 7.61 | 9.46 | 9.7 | 19.29 |
| | 20 min @ | | | | |
| | 70° C. | | | | |
| | Increase | | 24.% | 27.5% | 153.5% |
| Rheology | G′ [Pa] | 3357 | 4869 | 5201 | 8824 |
| | @0.005 Hz, | | | | |
| | 0.5% strain | | | | |
| | and 60° C. | | | | |
| | Increase | | 45.% | 54.9% | 162.9% |
| Rheology | Tan delta | 0.155 | 0.107 | 0.108 | 0.078 |
| | @ 0.005 Hz | | | | |
| | 0.5% strain | | | | |
| | and 60° C. | | | | |
| | Reduction | | −31.% | −30.3% | −49.7% |

As shown in the data above, the rubber compositions prepared from diluents composed of 100% highly reactive polyisobutene (HR-PIB) or mixtures of highly reactive polyisobutene (HR-PIB) and conventional polyisobutene (C-PIB) had a significantly higher elastic modulus G′ when compared to cured rubber compositions not prepared with HR-PIB. Additionally, the rubber compositions prepared from diluents composed of 100% highly reactive polyisobutene (HR-PIB) or mixtures of highly reactive polyisobutene (HR-PIB) and conventional polyisobutene (C-PIB) also had a significantly reduced loss factor tan delta when compared to cured rubber compositions not prepared with HR-PIB.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An uncured composition comprising:
an elastomer, a curing agent, a co-curative, and a diluent, wherein the diluent comprises a highly reactive polyisobutene that comprises at least about 60 mol % of terminal vinylidene groups.

2. The composition of claim 1, wherein the diluent consists of the highly reactive polyisobutene.

3. The composition of claim 1, wherein the diluent comprises a second diluent comprising a second polyisobutene comprising at most about 20 mol % terminal vinylidene groups, a hydrocarbon oil, or a combination thereof.

4. The composition of claim 3, wherein the weight ratio of the highly reactive polyisobutene to the second diluent is about 1:20 to about 20:1.

5. The composition of claim 3, wherein the weight ratio of the highly reactive polyisobutene to the second diluent is about 1:20 to about 1:2.

6. The composition of claim 3, wherein the second diluent comprises a second polyisobutene comprising at most about 10 mol % of terminal vinylidene groups.

7. The composition of claim 3, wherein the second diluent comprises a second polyisobutene comprising from about 5 mol % to at most 20 mol % of terminal vinylidene groups.

8. The composition of claim 3, wherein the second polyisobutene has an average molecular weight of about 500 Dalton to about 5,000 Dalton.

9. The composition of claim 3, wherein the second diluent comprises a hydrocarbon oil.

10. The composition of claim 3, wherein the hydrocarbon oil comprises a mineral oil, a vegetable oil, or a combination thereof.

11. The composition of claim 1, wherein the highly reactive polyisobutene comprises from about 60 mol % to less than 95 mol % terminal vinylidene groups.

12. The composition of claim 1, wherein the highly reactive polyisobutene has an average molecular weight of about 500 Dalton to about 5,000 Dalton.

13. The composition of claim 1, wherein the elastomer comprises repeat units formed by residues of monomers selected from one or more of ethylene, propylene, isobutene, butadiene, isoprene, styrene, acrylonitrile, and any combination thereof.

14. The composition of claim 1, wherein the curing agent is a quinoid selected from the group consisting of benzoquinone dioxime, p,p-dibenzoylquinone dioxime, dibenzoyl-p-quinone dioxime, p-dinitrosobenzene, N-methyl-N, 4-dinitrosoanilene, and any combination thereof.

15. The composition of claim 1, wherein the co-curative is an organic peroxide selected from the group consisting of a diaroyl peroxide, a diacyl peroxide, and a peroxyester.

16. The composition of claim 1, wherein the diluent is from about 50 weight percent to about 80 weight percent of the composition.

17. A vulcanized rubber composition comprising the uncured composition of claim 1 that has been vulcanized.

18. The composition in claim 17, wherein the composition after cure has an elastic modulus G′ at a strain of 6.1%, 70° C., and a frequency of 1.672 Hz based on ASTM D5289 that is at least 20% greater than the elastic modulus G′ of a cured composition that does not comprise a highly reactive polyisobutene, or
the composition after cure has an elastic modulus G′ at a strain of 0.5%, 60° C., and a frequency of 0.005 Hz based on ASTM D4440 that is at least 30% lower than the loss factor tan delta of a cured composition that does not comprise a highly reactive polyisobutene, or.
the composition after cure has a loss factor tan delta at a strain of 0.5%, 60° C., and a frequency of 0.005 Hz based on ASTM D4440 that is at least 30% lower than the loss factor tan delta of a cured composition that does not comprise a highly reactive polyisobutene.

19. An article comprising the vulcanized rubber composition of claim 17.

20. The article of claim 19, wherein the article comprises a tire or a component of a tire.
